(19) United States
(12) Patent Application Publication
(10) Pub. No.: US 2026/0080804 A1
(43) Pub. Date: Mar. 19, 2026

(54) EX VIVO EYE MODEL SYSTEM FOR SCREENING OCULAR PRODUCTS

(71) Applicant: Alcon Inc., Fribourg (CH)

(72) Inventors: Xinfeng Charlie Shi, Southlake, TX (US); James Yuliang Wu, Arlington, TX (US); Scott C. Bukosky, Roanoke, TX (US); Amanda K. Shows, Venus, TX (US); Daniel Matthew Esquivel, Suwanee, GA (US); Paul William Oyler, Cumming, GA (US); Lu Zhu, Duluth, GA (US); Qiaozhi Lu, Fort Worth, TX (US); Gregory L. Herron, Sugar Hill, GA (US)

(21) Appl. No.: 19/329,664

(22) Filed: Sep. 16, 2025

Related U.S. Application Data
(60) Provisional application No. 63/695,460, filed on Sep. 17, 2024.

(51) Int. Cl. G09B 23/32; G09B 23/30

(52) U.S. Cl. CPC G09B 23/32; G09B 23/303; G09B 23/306

(57) ABSTRACT

The present disclosure is directed to an ex vivo eye model system for screening ocular products with programmable blinking and tear flow control. In one example implementation, the ex vivo eye model system includes an eyeball core, an upper and lower eyelid frame, a servo, and a tear fluid delivery system. The eyeball core may be configured to hold a biological eye. The upper eyelid frame and the lower eyelid frame may be configured to replicate natural blinking actions and interact with the biological eye. The servo may be operatively connected to the upper eyelid frame and the lower eyelid frame. The servo may be configured to simulate controlled blinking actions by actuating the upper eyelid frame and the lower eyelid frame to move corresponding eyelid membranes of the biological eye. The tear fluid delivery system configured to deliver a fluid to an ocular surface of the biological eye.

This application claims the benefit under 35 U.S.C. § 119 (e) of U.S. provisional application number 63/695,460 filed 17 Sep. 2024, incorporated by reference in its entirety.

### BACKGROUND

The development of effective ocular products, including contact lenses, pharmaceuticals, and artificial tears, requires accurate preclinical testing to predict how these products will interact with the human eye. Traditional in vitro models have employed plastic eyes and eyelids, but these models often fail to replicate the biological and physiological conditions necessary to simulate true ocular interactions. Key issues with current models include the lack of ocular glycocalyx, improper tear spreading, and high variability in tear drainage, lens fitting, and blinking conditions. Consequently, there is a need for an ex vivo eye model system that may closely mimic the human ocular environment, providing reliable and repeatable results.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

One general aspect includes an ex vivo eye model system for evaluating ocular products. The ex vivo eye model system may include an eyeball core configured to hold a biological eye; an upper eyelid frame and a lower eyelid frame, each configured to replicate natural blinking actions and interact with the biological eye; a servo operatively connected to the upper eyelid frame and the lower eyelid frame, the servo configured to simulate controlled blinking actions by actuating the upper eyelid frame and the lower eyelid frame to move corresponding eyelid membranes of the biological eye; and a tear fluid delivery system configured to deliver a fluid to an ocular surface of the biological eye.

Implementations may include one or more of the following features. The ex vivo eye model system where the biological eye is a porcine eye, and the upper and lower eyelid frames are configured to interact with the corresponding eyelid membranes of the porcine eye. The ex vivo eye model system may include a linear motion stage connected to the base frame and configured to adjust a position of the eyeball core. The tear fluid delivery system may include a syringe pump connected to a tear fluid container via tubing, the syringe pump configured to deliver precise volumes of fluid to one or more tear fluid inlets on the upper eyelid frame, the lower eyelid frame, or both the upper eyelid frame and the lower eyelid frame. The tear fluid delivery system may include a drainage system configured to collect excess tear fluid from the ocular surface of the biological eye. The ex vivo eye model system may include a temperature control system, and a humidity control system configured to maintain environmental conditions around the biological eye. The ex vivo eye model system may include a computer system configured to control the servo and the tear fluid delivery system to replicate physiological ocular conditions. The computer system may be further configured to execute software to precisely manage a blinking rate and a tear flow rate. The upper eyelid frame and the lower eyelid frame may be adjustable to accommodate different sizes and types of biological eyes. The ex vivo eye model system may include an optical coherence tomography device and a slit lamp microscope, each configured to provide diagnostic imaging of the ocular surface of the biological eye.

One general aspect includes a method for evaluating an ocular product using an ex vivo eye model system. The method also includes providing a biological eye on an eyeball core of the ex vivo eye model system; delivering the ocular product onto an ocular surface of the biological eye using a tear fluid delivery system; simulating blinking actions with an upper eyelid frame and a lower eyelid frame controlled by a servo, monitoring the ocular surface of the biological eye using a diagnostic imaging device, collecting data from the diagnostic imaging device, and analyzing the collected data to assess the performance of the ocular product.

Implementations may include one or more of the following features. The method may include calibrating the servo and the tear fluid delivery system to replicate a specific physiological condition. The ocular product may include an artificial tear solution, an ophthalmic medication, or a contact lens solution. The method may include adjusting an environmental condition around the biological eye using a temperature control system and a humidity control system. The monitoring may include capturing one or more high-resolution images with an optical coherence tomography device to measure tear film thickness and stability. The method may include performing a blink rate simulation that replicates physiological blink patterns observed in humans. The method may include analyzing corneal epithelial integrity and mucin presence on the ocular surface using staining techniques. The ocular product is applied in varying volumes to simulate different ocular conditions. The analyzing may include comparing test results to baseline measurements or clinical data.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1A depicts a front view of an ex vivo eye model system according to an example implementation.

FIG. 1B depicts a left-side view of the ex vivo eye model system according to an example implementation.

FIG. 1C depicts a right-side view of the ex vivo eye model system according to an example implementation.

FIG. 1D depicts a back view of the ex vivo eye model system according to an example implementation.

FIG. 1E depicts a top view of the ex vivo eye model system according to an example implementation.

FIG. 1F depicts a bottom view of the ex vivo eye model system according to an example implementation.

FIG. 2 depicts an example configuration of the ex vivo eye model system integrating additional components to control blinking and tear flow and to monitor performance of the ex vivo eye model system according to an example implementation.

FIG. 3 depicts a method for using the ex vivo eye model system for testing according to an example implementation.

FIG. 4 depicts a method for conducting experiments with the ex vivo eye model system according to an example implementation.

FIG. 5 depicts a method for evaluating tear film stability using the ex vivo model system according to an example implementation.

### DETAILED DESCRIPTION

This disclosure relates to an advanced ex vivo eye model system designed for evaluating ocular products under controlled conditions that closely mimic the human eye. Traditional in vitro models, often made of plastic materials, have been used to evaluate ocular products, such as contact lenses and artificial tear solutions. However, these prior solutions suffer from significant limitations, including the inability to accurately replicate the physiological properties of the human eye. Specifically, these models lack the ocular glycocalyx and do not exhibit realistic tear spreading on the ocular surface. Furthermore, high variability in tear drainage, lens fitting, and blinking conditions have been of major concern, leading to inconsistent and unreliable test results.

The disclosed ex vivo eye model system overcomes these limitations by using a porcine eye, which provides a realistic and biologically relevant ocular surface. The ex vivo eye model system integrates programmable blinking mechanisms that may simulate human eyelid movement with high precision, and precise tear flow control systems that replicate natural tear production and drainage. Additionally, the ex vivo eye model system is designed to interface seamlessly with clinical diagnostic equipment, such as an Optical Coherence Tomography (OCT) system, keratography, tearscope, and/or slit lamp microscope, allowing for detailed analysis of tear film dynamics and ocular surface interactions. The ex vivo eye model system provides several advantages over prior solutions, including, for example, maintaining corneal surface integrity, simulating human physiological conditions, and enhanced repeatability in testing, making the ex vivo eye model system a superior platform for evaluating the performance of ocular products.

The present disclosure may be understood more readily by reference to the following detailed description of example implementations taken in connection with the accompanying drawing figures, which form a part of this disclosure. It is to be understood that the present disclosure is not limited to the specific apparatuses, methods, conditions, or parameters described and/or shown herein, and that the terminology used herein is for the purpose of describing particular implementations by way of example only and is not intended to limit the claims. Any and all patents and other publications identified in this specification are incorporated by reference as though fully set forth herein.

As used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another implementation includes from the one particular value and/or to the other particular value. Similarly, when values are expressed as approximations, by use of the antecedent “about,” it will be understood that the particular value forms another embodiment. As used herein, “about” means that a number, which is referred to as “about,” comprises the recited number plus or minus 1-10% of that recited number.

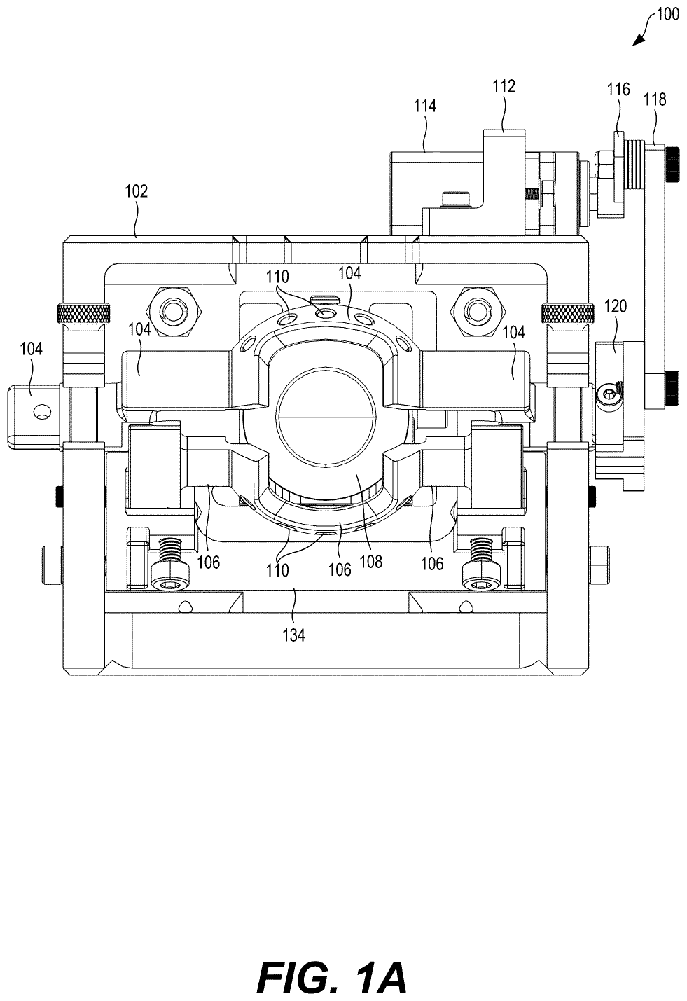

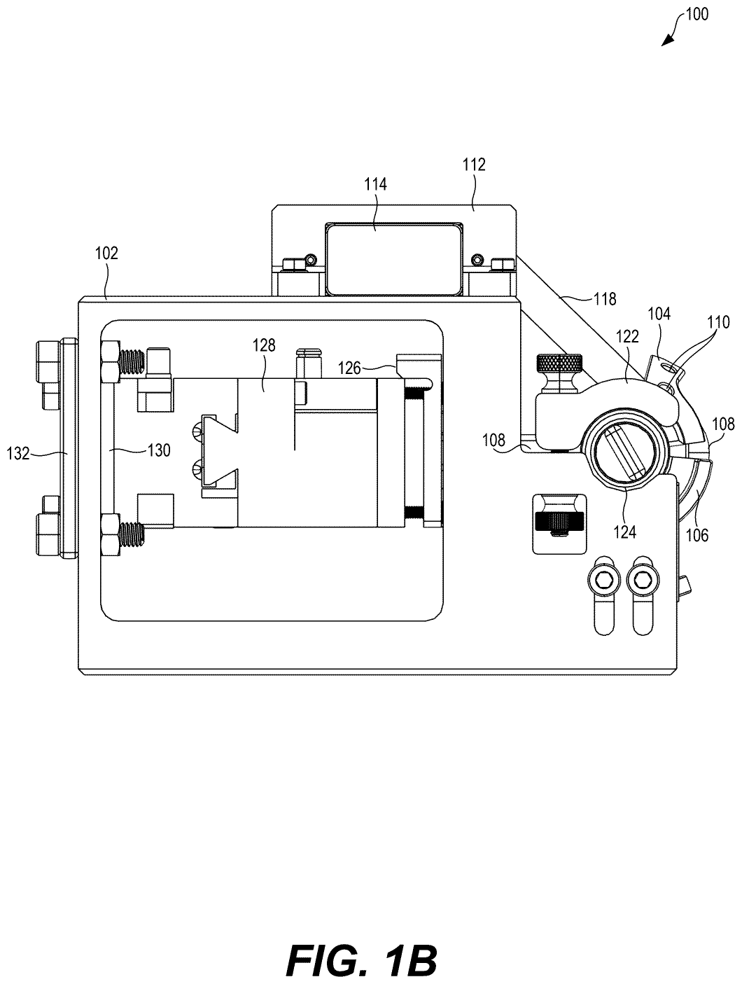

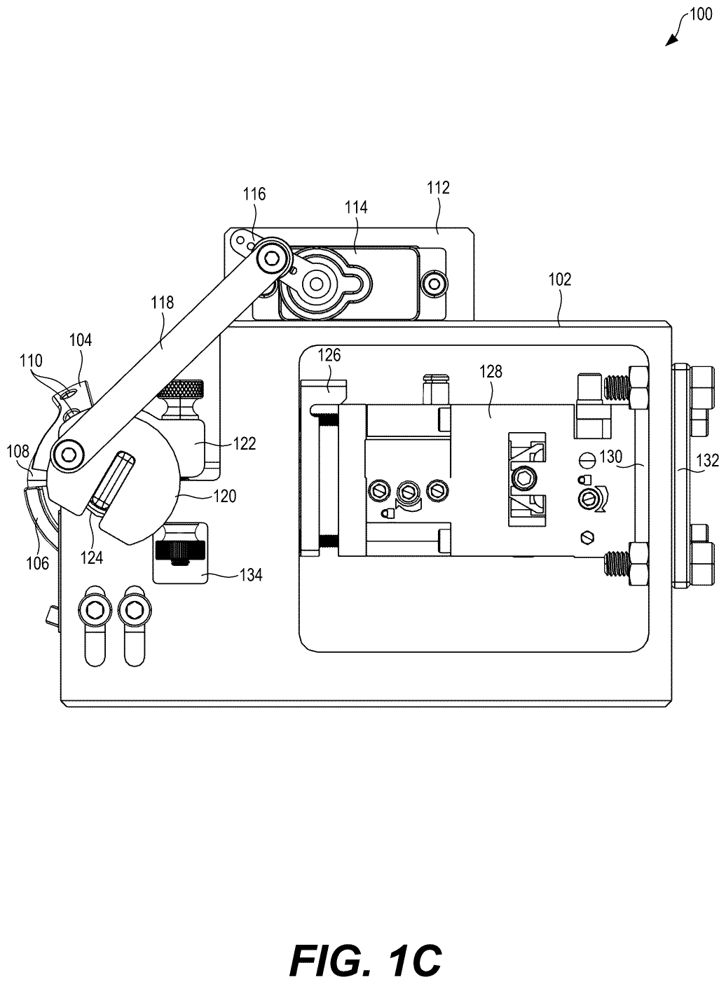

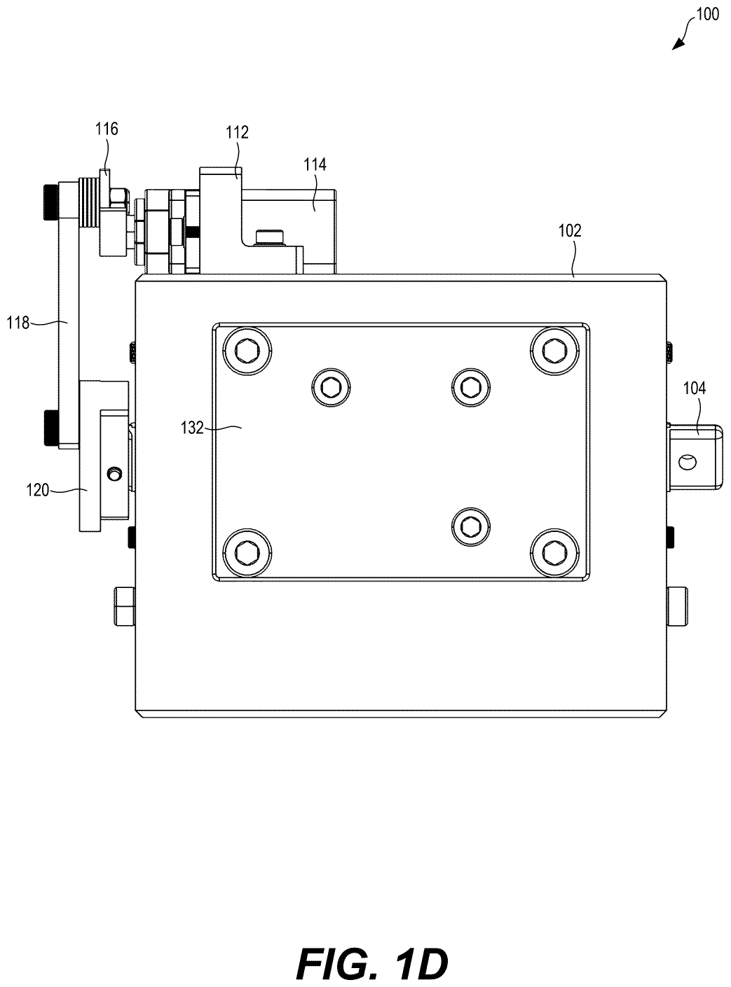

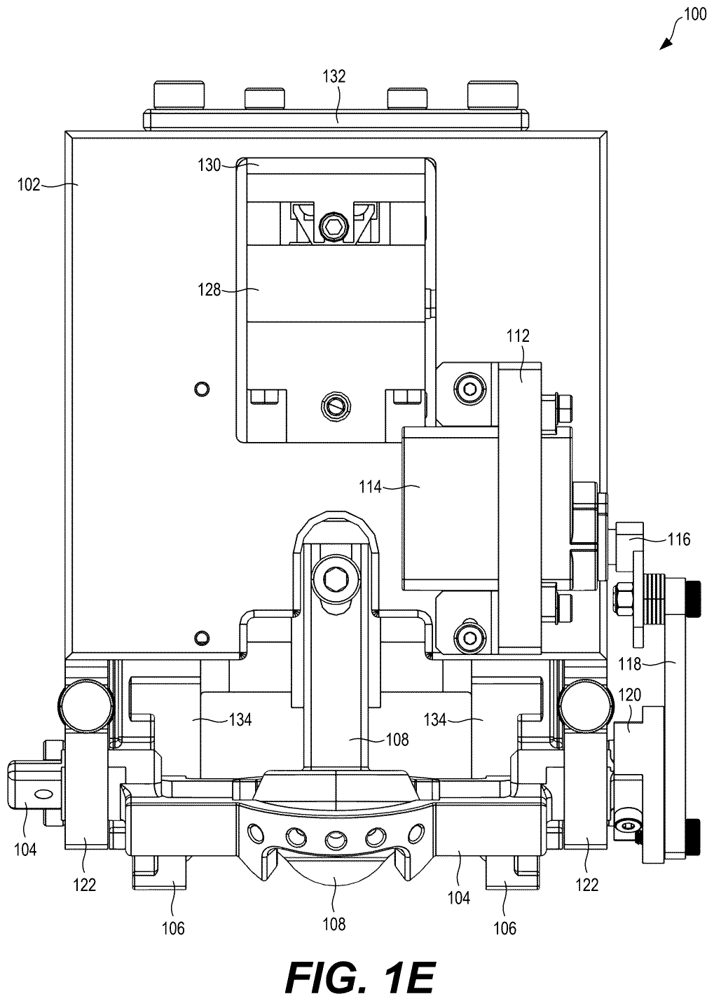

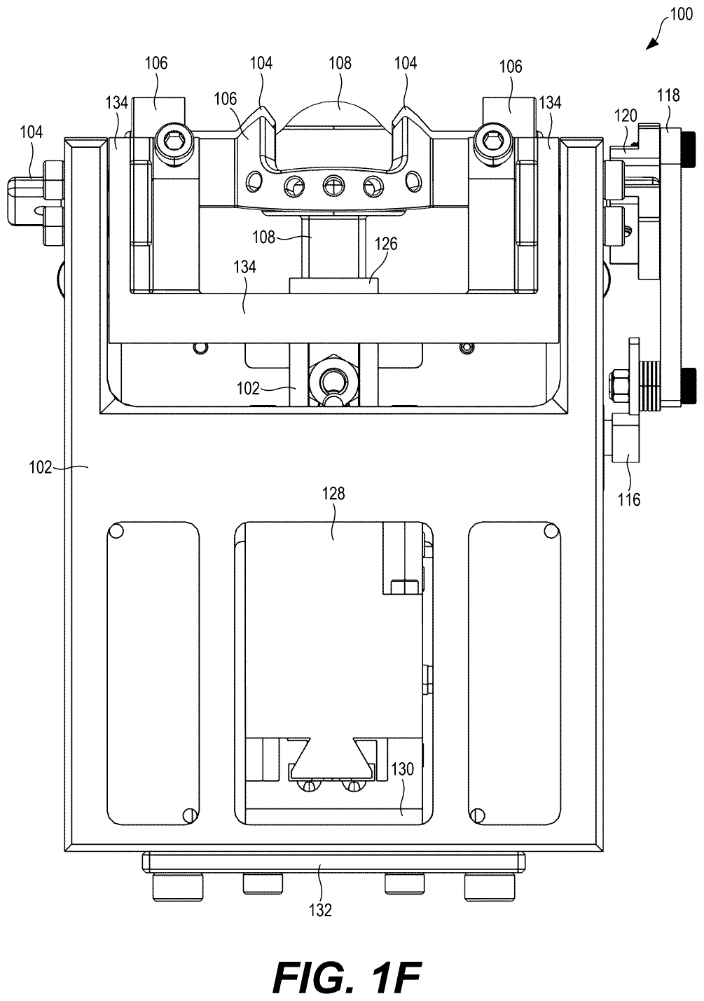

FIGS. 1A-1F depict various views of an ex vivo eye model system 100 according to an example implementation. Specifically, FIG. 1A is a front view, FIG. 1B is a left side view, FIG. 1C is a right side view, FIG. 1D is a back view, FIG. 1E is a top view, and FIG. 1F is a bottom view. The various components of the ex vivo eye model system 100 will be described with collective reference to FIG. 1A-1F. It should be noted that not all components are visible in all views.

The ex vivo eye model system 100 is designed to integrate a biological eye, such as a porcine eye. A porcine eye, for example, has anatomical and physiological similarities to the human eye, including the cornea, sclera, and pupil. The porcine eye has an upper eyelid and a lower eyelid. Thus, a porcine eye is capable of accurately mimicking human ocular conditions. It should be understood, however, that other biological eyes may be used or a combination of a biological eye and artificial eyelid membranes.

The ex vivo eye model system 100 includes a base frame 102 that serves as the structural foundation of the ex vivo eye model system 100 to provide stability and support for the mounted component components. The base frame 102 may be constructed from a rigid and durable material, such as stainless steel, aluminum, or high-density polyethylene, to ensure that the base frame 102 may securely hold the various components of the ex vivo eye model system 100. While the base frame 102 is primarily described as being constructed from stainless steel or aluminum due to their durability and rigidity, alternative materials could include carbon fiber composites or titanium alloys, which offer high strength-to-weight ratios and corrosion resistance. These materials could be particularly beneficial in environments where weight reduction or resistance to harsh chemicals is required. Additionally, the use of modular components that may be easily replaced or reconfigured would allow the base frame 102 to adapt to different experimental setups or space constraints, providing greater flexibility in research applications.

The base frame 102 is designed with multiple mounting points, which are positioned to accommodate the attachment of different components described below, and other structural and/or functional components. Although not labeled, the illustrated base frame 102 has mounting points configured to align with the components and to accept thumb screws, bolts, washers, other types of fasteners, or combinations thereof. In this manner, components may be easily installed, adjusted, and removed as needed.

An upper eyelid frame 104 and a lower eyelid frame 106 are each mounted to the base frame 102 at one or more mounting points. The upper eyelid frame 104 and the lower eyelid frame 106 are designed to rotate to simulate the natural blinking action of human eyelids while closely interacting with corresponding eyelid membranes of a biological eye, such as a porcine eye.

The upper eyelid frame 104 may be designed to replicate the motion and function of a human upper eyelid by moving up and down over the surface of the porcine eye. The upper eyelid frame 104 may surround the natural upper eyelid membrane of the porcine eye, which is preserved and incorporated into the model to maintain anatomical accuracy. This setup ensures that the upper eyelid frame 104 interacts directly with the biological tissue, providing a realistic simulation of human eyelid motion. Alternatively, the upper eyelid frame 104 may be attached to, formed as part of, or otherwise provide structure for an artificial eyelid, which may be made from a flexible material, such as silicone rubber, soft plastic, an artificial skin, or the like.

The upper eyelid frame 104, in conjunction with the porcine upper eyelid membrane or an artificial eyelid, helps distribute tear fluid evenly across the corneal surface to simulate the natural function of a human blink. In this manner, a stable tear film may be maintained to protect the cornea and to provide realistic conditions for testing ophthalmic products such as contact lenses, eye drops, and other formulations. For example, in a test scenario evaluating a new lubricating eye drop, the upper eyelid frame 104 ensures that the drop is spread evenly across the ocular surface, mimicking natural blink dynamics.

The lower eyelid frame 106 may be designed to replicate the function of a human lower eyelid, moving upward in coordination with the upper eyelid frame 104 to simulate a complete blinking action. The lower eyelid frame 106 may surround the natural upper eyelid membrane of the porcine eye, which is preserved and incorporated into the model to maintain anatomical accuracy. This setup ensures that the lower eyelid frame 106 interacts directly with the biological tissue, providing a realistic simulation of human eyelid motion. Alternatively, the lower eyelid frame 106 may be attached to, formed as part of, or otherwise provide structure for an artificial eyelid, which may be made from a flexible material, such as silicone rubber, soft plastic, an artificial skin, or the like.

The lower eyelid frame 106 works in conjunction with the upper eyelid frame 104 to create a full blinking action that covers the porcine cornea. By interacting with the biological tissue of the porcine lower eyelid membrane or an artificial replicant thereof, the lower eyelid frame 106 ensures a realistic simulation of the ocular surface's interaction with blinking eyelids. This enables accurate performance testing of ophthalmic products, such as determining the retention of tear supplements or the comfort of contact lenses under natural blink conditions. For instance, during the evaluation of a new contact lens design, the lower eyelid frame 106 helps assess how the lens moves and interacts with the ocular surface during blinking.

An eye core 108 may be centrally mounted on the base frame 102 using an eye mount 126 (best shown in FIG. 1F), which is securely fastened to the base frame at one or more mounting points and allows for precise positioning and alignment with diagnostic instruments. The eye core 108 may be made from a rigid, biocompatible material that provides structural support for the biological eye to ensure that the biological eye remains securely in place during testing procedures. It should be noted that the eye core 108 is described as an apparatus designed to hold the biological eye rather than being the eye itself. The eye core 108, for instance, may be inserted into the biological eye such that the eye maintains its shape during testing. Alternatively, the eye may be filled with a buffered solution (e.g., saline) before mounting the eye onto the eye core 108, such as via an adhesive.

The upper eyelid frame 104 and the lower eyelid frame 106 both have one or more tear fluid inlets 110. The tear fluid inlets 110 may be configured to accommodate flexible tubing (e.g., plastic, polyurethane, or silicone) through which artificial tear fluid, medicine, and/or other fluids may be administered to the ocular surface of the porcine eye. The fluid may be held in a container and manually or automatically pumped through the tubing and the tear fluid inlets 110 and onto the ocular surface. The tear fluid inlets 110 may be positioned to ensure even distribution of fluid during the blinking cycle.

In one or more implementations, the tear fluid inlets 110 may be or may include one or more microfluidic channels. Microfluidic channels would allow for more precise control over the fluid dynamics, such as varying flow rates and targeted delivery locations, which could be useful when simulating specific ocular conditions, like dry eye syndrome or excessive tear production. The use of peristaltic pumps as an alternative to syringe pumps could also provide continuous, pulsatile fluid flow, mimicking the natural secretion patterns of the lacrimal glands.

A servo base 112 is mounted on the base frame 102 using specific mounting points that provide a stable platform for a servo 114, which drives the movement of the upper eyelid frame 104 and lower eyelid frame 106. The servo 114 may be a compact, electrically powered device encased in a housing made from aluminum or reinforced plastic to ensure durability. Inside the motor housing, a rotor is driven by electric currents controlled through a feedback loop, allowing precise angular positioning. A servo arm 116 is attached to an output shaft of the servo 114 and extends horizontally to link with a connector arm 118. The connector arm 118 attaches to the upper eyelid frame 104 to convert the rotational motion of the servo 114 into the linear motion used for the blinking action. Both the servo arm 116 and connector arm 118 may be secured to their respective components using thumb screws, bolts, and/or other fasteners to allow for easy adjustments and replacement if needed. Alternatives to the servo 114 may include linear actuators or cam-driven systems, which may offer smoother and more precise movement if needed.

A servo coupler 120 is a flexible coupling device that connects the servo arm 116 to the rotating mechanism to ensure a smooth transmission of motion. The servo coupler 120 is designed to absorb any misalignment or vibrations and to ensure the precision of the blinking action and reducing wear on the mechanical components. The servo coupler 120 may be made from materials like flexible rubber or high-strength composite, depending on the requirements of the application.

As shown in FIGS. 1B and 1C, two bearing covers 122 and two bearings 124 are mounted on the base frame 102 to facilitate smooth movement of the upper eyelid frame 104 and the lower eyelid frame 106 during blinking. The bearings 124 allows for low-friction movement to better simulate natural eyelid motion. The bearing covers 122, also shown in FIG. 1F, protects the bearings 124 from dust and debris. The bearings 124 may be ball bearings, roller bearings, or other bearing types, depending on the specific design requirements. Alternatives to a covered bearing system may include self-lubricating bearings or bushings, which may reduce maintenance needs.

As also shown in FIGS. 1B and 1C, an eye mount 126 is connected to a linear motion stage 128, which allows for fine adjustments in the position of the eye core 108. The linear motion stage 128 is mounted on the base frame 102 using a linear motion stage spacer 130, which ensures proper alignment and spacing between components. FIGS. 1E and 1F show a top and bottom view of the linear motion stage 128 mounted to the base frame 102 via the linear motion stage spacer 130.

As shown in FIGS. 1B-1E, a back plate 132 is attached to the base frame 102. The back plate 132 encloses the back portion of the base frame 102 to enclose and protect the linear motion stage 128. The back plate 132 may provide additional structural support and stability to the base frame 102. The back plate 132 may also serve as a mounting point for additional accessories, testing instruments, environmental control devices, and/or the like.

As shown in FIGS. 1A, 1C, 1E, and 1F, an eyelid slide 134 is connected to the lower eyelid frame 106. The eyelid slide 134 allows for precise positioning of a lower eyelid mounted to the lower eyelid frame 106.

The example configuration of the ex vivo eye model system 100 depicted in FIGS. 1A-1F is designed with versatility and adaptability to accommodate a variety of experimental needs and research applications. The ex vivo eye model system 100 may be constructed in different sizes, shapes, materials, and configurations to provide flexibility to meet specific requirements for different types of ophthalmic testing.

The ex vivo eye model system 100 may be manufactured in various sizes and shapes to suit different experimental setups and space constraints. The base frame 102, for instance, may be made larger or smaller depending on the dimensions of the laboratory equipment or the scale of the testing environment. The shapes of components such as the upper eyelid frame 104, lower eyelid frame 106, and eye core 108 may also be customized to replicate different anatomical variations or to fit different types of eyes, such as human eyes, animal eyes, or artificial models.

The materials used in the construction of the ex vivo eye model system 100 may vary based on the specific application requirements. Components like the base frame 102 and servo base 112 may be made from high-strength materials such as stainless steel or aluminum for durability and stability. Alternatively, lightweight materials like high-density polyethylene or reinforced plastics may be used when portability or ease of handling is a priority. The upper eyelid frame 104 and the lower eyelid frame 106 may also be fabricated from other biocompatible materials like medical-grade thermoplastic elastomers or polyurethanes, depending on the desired level of flexibility and tactile response.

The ex vivo eye model system 100 is modular and highly configurable, allowing for the easy addition, removal, or replacement of components to suit various testing scenarios. The ex vivo eye model system 100 may be expanded by integrating additional components such as multiple servo motors for independent control of each eyelid frame, or different types of pumps to deliver various ophthalmic formulations. The tear fluid delivery system may be modified to include advanced microfluidic channels for more precise control of tear flow, or peristaltic pumps for different fluid dynamics studies.

The ex vivo eye model system 100 may be configured in multiple ways to meet the specific needs of different types of ophthalmic research. For example, in a configuration for studying contact lens interactions, the ex vivo eye model system 100 might include additional mounts for imaging devices such as slit lamp microscopes or Optical Coherence Tomography (OCT) devices. In another configuration for testing eye drops or pharmaceutical formulations, the ex vivo eye model system 100 might be equipped with enhanced temperature and humidity control systems to replicate human ocular conditions more accurately.

The design of the ex vivo eye model system 100 is intentionally expandable to allow for future enhancements and upgrades. Additional components such as more advanced sensors for monitoring tear film dynamics, or robotic arms for automated application of ophthalmic products, may be integrated as needed. The modular nature of the ex vivo eye model system 100 ensures that new technologies and methodologies may be easily incorporated, providing a robust platform for ongoing research and development in the field of ophthalmology.

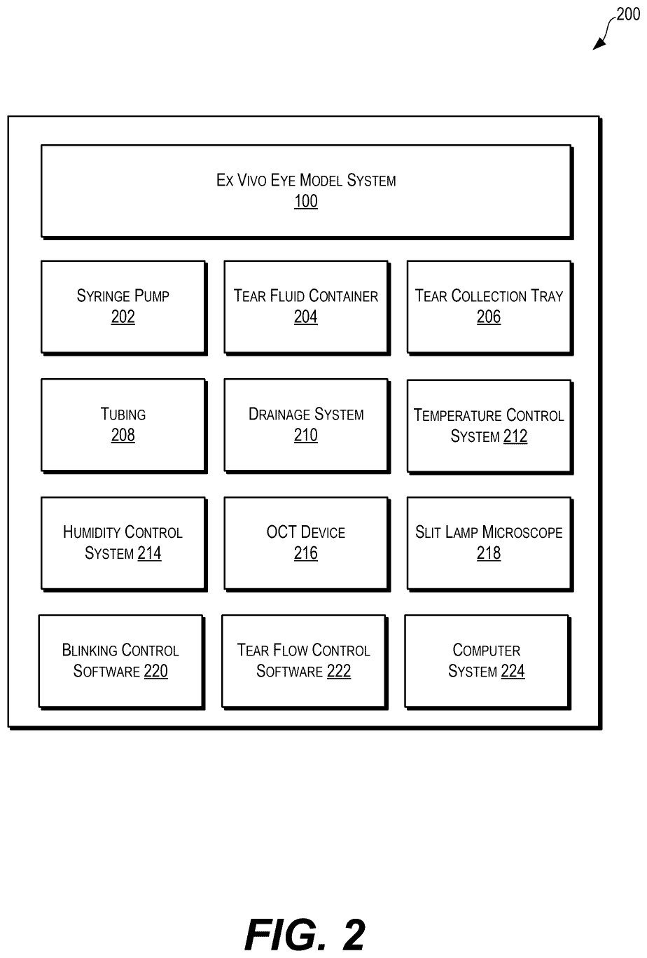

Turning to FIG. 2, shown is an example configuration 200 of the ex vivo eye model system 100 integrating additional components to control blinking and tear flow and to monitor performance of the ex vivo eye model system 100 according to an example implementation. The example configuration 200 includes the ex vivo eye model system 100, a syringe pump 202, a tear fluid container 204, a tear collection tray 206, tubing 208, a drainage system 210, a temperature control system 212, a humidity control system 214, an OCT device 216, a slit lamp microscope 218, blinking control software 220, tear flow control software 222, and a computer system 224.

The syringe pump 202 is used to deliver precise volumes of tear fluid or test formulations onto the corneal surface of the porcine eye. There are several types of syringe pumps that may be utilized in this context, each offering different mechanisms and levels of control, depending on the experimental requirements. Some example pump types include, but are not limited to, motor-driven syringe pumps, electro-mechanical syringe pumps, peristaltic syringe pumps, microfluidic syringe pumps, infusion/withdrawal syringe pumps, combinations thereof, and/or the like. Although syringe pumps 202 are described, other pump types may be used.

The syringe pump 202 is connected to a tear fluid container 204, which stores the tear fluid in a sterile environment to maintain its integrity throughout the experiment. Additional or alternative fluid containers may be attached to the same or different syringe pump(s) to administer other fluids, such as medicine. Excess tear fluid is collected in a tear collection tray 206 that is drained out the back of the eye or when the eye is flooded with tear fluid to make the eye “cry. ”

The syringe pump 202 may be connected to the tear fluid container 204 directly or via tubing 208 (e.g., silicone, rubber, plastic, or the like). The tubing 208 may be designed to friction fit into the tear fluid inlets 110 of the upper eyelid frame 104 and the lower eyelid frame 106 or may be secured by clamps or other fasteners. The tubing 208 may also be used for drainage into a drainage system 210.

The drainage system 210 may remove excess fluid from the eye to prevent overflow and to maintain a stable experimental environment. The drainage system 210 may incorporate sensors or flow meters to provide real-time data on fluid management to ensure consistent conditions throughout the testing process.

Environmental control is also a critical aspect of the ex vivo eye model system 100. A temperature control system 212 may be used to maintain a stable temperature around the eye to replicate physiological conditions accurately. The temperature control system 212 may include various heating or cooling elements, such as thermoelectric devices, to regulate the temperature based on the experimental requirements. Similarly, a humidity control system 214 may be used to control the moisture levels in the testing environment, utilizing humidifiers or dehumidifiers to achieve the desired humidity levels. Both the temperature control system 212 and the humidity control system 214 ensure that the environment closely mimics that of a human eye, providing reliable and reproducible experimental conditions.

The example configuration 200 also includes advanced diagnostic tools, such as an OCT device 216 and a slit lamp microscope 218, which are used for detailed examination and imaging of the eye. The OCT device 216 captures high-resolution, cross-sectional images of the eye. The images may be analyzed to determine tear film thickness and corneal integrity in detail. The slit lamp microscope 218 provides magnified views of the corneal surface and tear film and may aid in the assessment of the anterior segment of the eye.

The ex vivo eye model system 100 may be controlled by specialized software, including blinking control software 220 and tear flow control software 222. These software programs run on a computer system 224, which may be a desktop, laptop, tablet, smartphone, or the like, or can otherwise be implemented as part of a human-machine interface (HMI). The computer system 224 may be local or may be accessible remotely via one or more networks. The blinking control software 220 allows precise control over the blinking mechanism of the ex vivo eye model system 100. The tear flow control software 222 controls tear flow rates for simulating various ocular conditions and adjust parameters in real-time to meet the specific needs of various experiments.

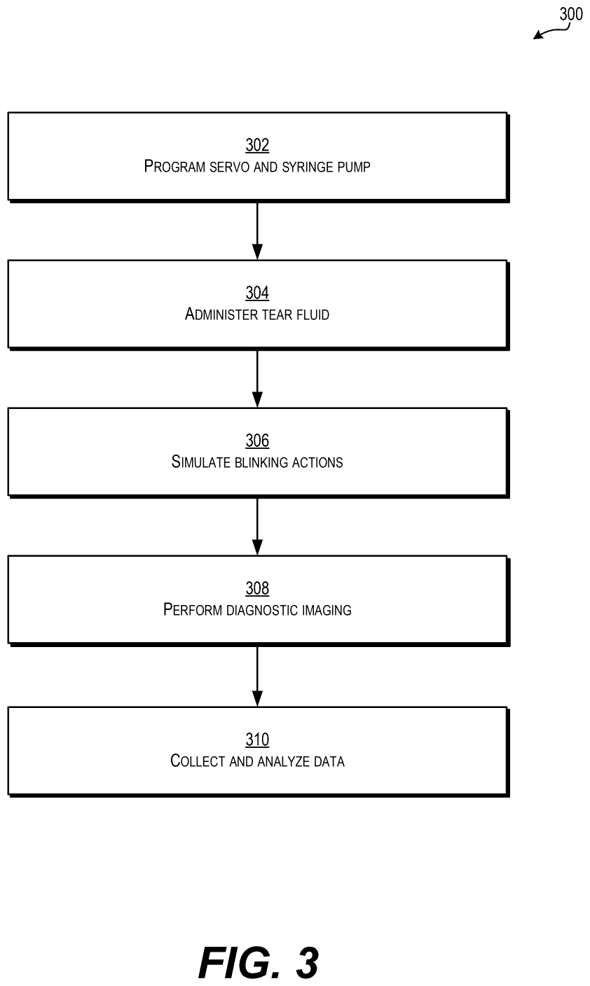

Turning to FIG. 3, a method 300 is shown for using the ex vivo eye model system 100 for testing according to an example implementation. It should be understood that the operations of the method 300 and the other methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

The method 300 begins and proceeds to block 302. At block 302, a testing procedure begins with the programming of the servo 114 and the syringe pump 202. Programming of these components ensures precise control over the blinking mechanism and tear flow. Using the blinking control software 220 installed on the computer system 224, specific parameters such as blink rate and blink duration may be configured to match the experimental conditions. The programming process may include both static tests, where the system operates at a steady state, and dynamic tests, where the ex vivo eye model system 100 responds to changes in real-time. For example, in an experiment designed to test a new lubricant eye drop, the tear fluid delivery may be programmed via the tear flow control software 222 to replicate the average human tear production rate, which is approximately 1 to 2 microliters per minute. The blinking control software 220 may be used to adjust the movement of the servo to simulate different blink rates, such as faster blinks during reading, slower blinks when staring at a screen, or to mimic faster blinking rates of a dry eye patient.

At block 304, tear fluid is administered through the tear fluid inlets 110. Specifically, the syringe pump 202 collects an amount of tear fluid from the tear fluid container 204 and pumps the tear fluid through the tubing 208 and into the tear fluid inlets 110. The tear fluid inlets 110 distribute the tear fluid onto the ocular surface of the eye to simulate natural tear production and distribution. The tear fluid, such as an artificial tear solution or a specific ophthalmic formulation under test, may be delivered consistently to maintain a stable tear film. The flow rate from the syringe pump 202 may be continuously monitored via the tear flow control software 222 and may be adjusted in real-time to ensure that the tear fluid is dispensed evenly across the corneal surface.

At step 306, blinking actions are simulated using the servo 114, which controls the movement of the upper eyelid frame 104 and the lower eyelid frame 106. The blinking action helps to replicate the natural clearing of the tear film and the distribution of ophthalmic formulations across the ocular surface. The movement of the servo 114 may be precisely controlled to simulate natural human blink rates and durations, typically around 15 to 20 blinks per minute, although this rate may be adjusted based on the experimental requirements. Adjustments may be made to the blink parameters to simulate various physiological conditions, such as an increased blink rate during reading or a decreased blink rate during screen use. These simulations are particularly useful for testing how ophthalmic formulations or contact lenses perform under different conditions, providing insights into their retention, distribution, and overall effectiveness.

At block 308, diagnostic imaging may be performed by one or more instruments such as the OCT device 216 and the slit lamp microscope. The images captured at block 308 may be used to analyze tear film dynamics, corneal integrity, and other ocular parameters. The OCT device 216, for example, generates high-resolution, cross-sectional images of the eye's structures, allowing for detailed analysis of the tear film thickness, corneal surface, and the interaction of the tested formulations with the ocular surface. The slit lamp microscope 218 provides a magnified view of the cornea to aid in viewing any changes or abnormalities caused by the ophthalmic products. The data gathered may be used to evaluate the effectiveness and safety of the products being tested.

At block 310, after the diagnostic imaging is complete, the data generated by the ex vivo eye model system 100 is collected and analyzed. The data analysis focuses on evaluating the performance of the tested ophthalmic products, particularly in terms of their impact on tear film stability, product distribution on the cornea, and overall ocular health. Software tools installed on the computer system 224 may be used to process the collected data, providing detailed metrics such as tear film break-up time, corneal staining patterns, and mucin interaction. The results may be compared with clinical benchmarks, control samples, and/or baselines to validate the findings and determine the product's efficacy. This analysis may aid in understanding the product's performance under simulated physiological conditions.

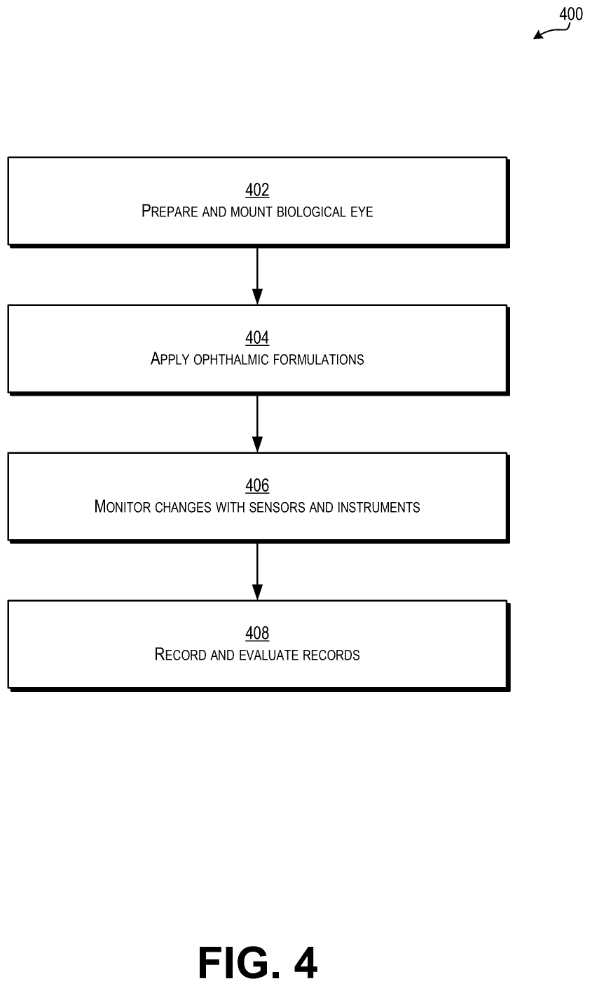

Turning to FIG. 4, a method 400 is shown for conducting experiments with the ex vivo eye model system 100 according to an example implementation. The method 400 begins and proceeds to block 402. At block 402, the biological eye (e.g., a porcine eye) is prepared and mounted to the ex vivo eye model system 100. For example, the biological eye may be rinsed with a sterile saline solution to remove any residual debris or contaminants from the transportation or storage process. The ocular surface, in particular, may be cleaned to accurately mimic physiological conditions of a healthy and clean human eye. The biological eye might also be trimmed to remove excess/dead tissue, such as muscle, fat, or optic nerve tissue. A uniform shape and size may minimize any obstruction that could interfere with mounting or subsequent imaging processes. The biological eye may be mounted on the eye core 108 such that the cornea is facing upwards and directly aligned with any diagnostic instruments that will be used during the testing process.

At block 404, the ophthalmic formulations to be tested are applied directly onto the ocular surface of the eye. The ophthalmic formulations can be administered, for instance, via a variable pipette.

At block 406, various sensors and/or diagnostic instruments may be used to monitor changes in the ocular environment. These instruments, such as the OCT device 216, the slit lamp microscope 218, and/or other specialized equipment (e.g., keratography and/or tearscope), provide real-time data on tear film thickness, distribution, and stability. For example, the OCT device may be used to capture high-resolution images of the tear film, which may provide insight into the effectiveness of the ophthalmic product being tested. Additionally, the temperature control system 212 and the humidity control system 214 may be used to monitor and control environmental conditions that may affect the results.

At block 408, the data collected at block 406 may be recorded and evaluated using specialized software tools. The analysis focuses on several metrics, including tear film break-up time, corneal staining patterns, mucin interaction, and other relevant indicators of ocular health. The recorded data may be compared against clinical benchmarks or control samples to determine the ophthalmic product's performance. For example, a product that demonstrates a longer tear film break-up time compared to the control may be considered more effective in maintaining tear film stability. This step aids in understanding the product's impact on the eye and may provide valuable insights for further development and potential clinical applications. The results are documented, and any anomalies or unexpected outcomes may be further investigated to ensure the reliability and validity of the findings.

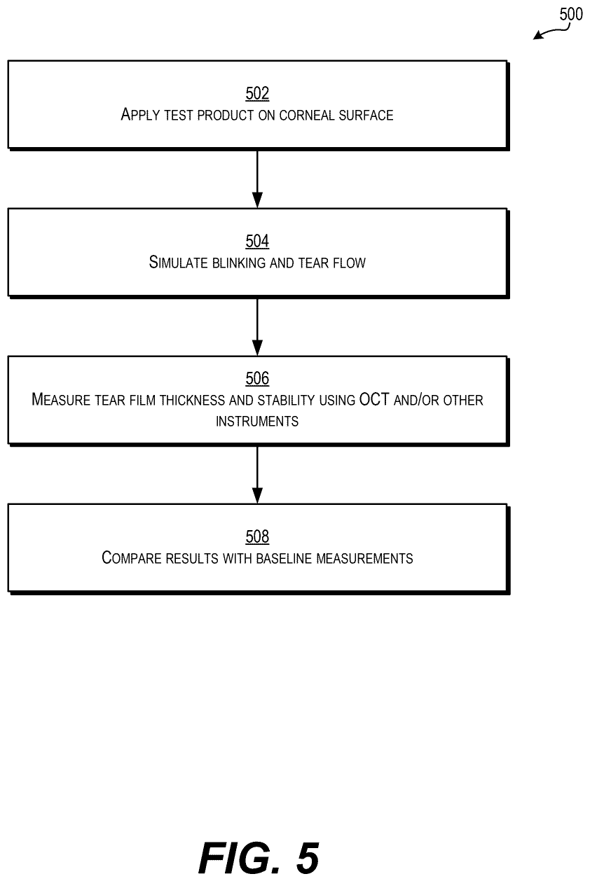

Turning to FIG. 5, a method 500 is shown for evaluating tear film stability using the ex vivo eye model system 100 according to an example implementation. The method 500 begins and proceeds to block 502. At block 502, a test product is applied to the corneal surface of the biological eye. The test product may be any ophthalmic fluid, such as artificial tear solution, contact lens solution, or medicine. The test product may be applied manually or via an automated system.

At block 504, the ex vivo eye model system 100 simulates physiological blinking and tear flow using the servo 114 and the tear fluid delivery system. The servo 114 controls the movement of the upper eyelid frame 104 and the lower eyelid frame 106 to replicate natural blinking actions, while the tear fluid delivery system (i.e., the syringe pump 202, the tubing 208, and the tear fluid inlets 110) administers a controlled flow of artificial tears and/or test formulations onto the corneal surface. The servo 114 may be controlled by the blinking control software 220 to ensure the correct blinking rate is used to match specific experimental conditions, such as normal physiological blinking rates. The syringe pump 202 may be controlled by the tear flow control software 222 to ensure that the tear flow is adjusted to match specific experimental conditions, such as to mimic dry eye syndrome. In this scenario, the tear flow can be regulated to create a smaller tear meniscus height on the porcine eye, closely resembling the reduced tear volume typically observed in dry eye patients. By precisely controlling the tear meniscus height, researchers can simulate the conditions of a dry eye patient and evaluate the performance of ophthalmic products designed to address tear film deficiencies. The tear meniscus height can then be measured using instruments like a keratograph or tearscope, allowing for accurate assessment of the product's ability to stabilize or improve the tear film under these specific conditions. This simulation provides a comprehensive assessment of the efficacy of a test product in maintaining tear film stability and treating dry eye symptoms.

At block 506, the OCT device 216 and/or other instruments is/are used to measure the thickness and stability of the tear film on the corneal surface. The OCT device 216 provides high-resolution, cross-sectional images of the tear film, allowing for detailed analysis of its uniformity and thickness over time. Measurements may be taken before, during, and after the application of the test product to assess its impact on the tear film. For example, when testing an artificial tear solution, the OCT device 216 may monitor how the solution spreads across the ocular surface and whether the artificial tear solution improves tear film stability over a series of blink cycles. Similarly, when testing a contact lens, the OCT device 216 may measure tear film thickness before and after lens application to determine any changes caused by the lens.

At block 508, the data collected from the measurements at block 506 may be compared with baseline measurements taken prior to the application of the test product. This comparison helps determine the efficacy of the product in maintaining or improving tear film stability. Baseline measurements provide a reference point for understanding the natural tear film dynamics without any intervention. The comparison involves analyzing various metrics such as tear film thickness, break-up time, and uniformity. For instance, a significant improvement in tear film stability compared to baseline measurements indicates that the test product effectively enhances ocular surface hydration and protection.

Additional assessments may be conducted to evaluate the corneal epithelial integrity and the presence of ocular mucins on the corneal surface. Sodium fluorescein staining may be used to assess corneal epithelial integrity, highlighting any areas of damage, or compromised epithelial cells. This step is particularly useful for determining the safety and compatibility of the test product with the corneal surface. Following this, lectin staining may be employed to detect the presence of ocular mucins, which are needed for maintaining tear film stability and ocular surface health. The presence and distribution of mucins provide insights into the protective effects of the test product and its ability to preserve or enhance the natural tear film structure.

It should be understood that many variations are possible based on the disclosure herein. Although features and elements are described above in particular combinations, each feature or element is usable alone without the other features and elements or in various combinations with or without other features and elements.

While the disclosure has been described with reference to example embodiments, it will be understood by those skilled in the art that a variety of modifications, additions and deletions are within the scope of the disclosure, as defined by the following claims.

What is claimed is:

1. An ex vivo eye model system for evaluating ocular products, comprising: a base frame configured to support and stabilize components of the ex vivo eye model system;
an eyeball core configured to hold a biological eye;
an upper eyelid frame and a lower eyelid frame, each configured to replicate natural blinking actions and interact with the biological eye;
a servo operatively connected to the upper eyelid frame and the lower eyelid frame, the servo configured to simulate controlled blinking actions by actuating the upper eyelid frame and the lower eyelid frame to move corresponding eyelid membranes of the biological eye; and
a tear fluid delivery system configured to deliver a fluid to an ocular surface of the biological eye.

2. The ex vivo eye model system of claim 1, wherein the biological eye is a porcine eye, and the upper eyelid frame and the lower eyelid frame are configured to interact with the corresponding eyelid membranes of the biological eye.

3. The ex vivo eye model system of claim 1, further comprising a linear motion stage connected to the base frame and configured to adjust a position of the eyeball core.

4. The ex vivo eye model system of claim 3, wherein the tear fluid delivery system comprises a syringe pump connected to a tear fluid container via tubing, the syringe pump configured to deliver precise volumes of fluid to one or more tear fluid inlets on the upper eyelid frame, the lower eyelid frame, or both the upper eyelid frame and the lower eyelid frame.

5. The ex vivo eye model system of claim 4, wherein the tear fluid delivery system further comprising a drainage system configured to collect excess tear fluid from the ocular surface of the biological eye.

6. The ex vivo eye model system of claim 1, further comprising a temperature control system and a humidity control system configured to maintain environmental conditions around the biological eye.

7. The ex vivo eye model system of claim 6, further comprising a computer system configured to control the servo and the tear fluid delivery system to replicate physiological ocular conditions.

8. The ex vivo eye model system of claim 7, wherein the computer system is further configured to execute software to precisely manage a blinking rate and a tear flow rate.

9. The ex vivo eye model system of claim 8, wherein the upper eyelid frame and the lower eyelid frame are adjustable to accommodate different sizes and types of biological eyes.

10. The ex vivo eye model system of claim 9, further comprising an optical coherence tomography device and a slit lamp microscope, each configured to provide diagnostic imaging of the ocular surface of the biological eye.

11. A method for evaluating an ocular product using an ex vivo eye model system, comprising:
providing a biological eye on an eyeball core of the ex vivo eye model system;
delivering the ocular product onto an ocular surface of the biological eye using a tear fluid delivery system;
simulating blinking actions with an upper eyelid frame and a lower eyelid frame controlled by a servo;
monitoring the ocular surface of the biological eye using a diagnostic imaging device;
collecting data from the diagnostic imaging device; and
analyzing the collected data to assess a performance of the ocular product.

12. The method of claim 11, further comprising calibrating the servo and the tear fluid delivery system to replicate a specific physiological condition.

13. The method of claim 12, wherein the ocular product comprises an artificial tear solution, an ophthalmic medication, or a contact lens solution.

14. The method of claim 13, further comprising adjusting an environmental condition around the biological eye using a temperature control system and a humidity control system.

15. The method of claim 11, wherein the monitoring comprises capturing one or more high-resolution images with an optical coherence tomography device to measure tear film thickness and stability.

16. The method of claim 15, further comprising performing a blink rate simulation that replicates physiological blink patterns observed in humans.

17. The method of claim 16, further comprising analyzing corneal epithelial integrity and mucin presence on the ocular surface using staining techniques.

18. The method of claim 17, wherein the ocular product is applied in varying volumes to simulate different ocular conditions.

19. The method of claim 11, wherein the analyzing comprises comparing test results to baseline measurements or clinical data.

20. The method of claim 11, further comprising adjusting a position of the biological eye using a linear motion stage to optimize imaging and fluid delivery.
